(19) United States
(12) Patent Application Publication
(10) Pub. No.: US 2004/0086305 A1
(43) Pub. Date: May 6, 2004

(54) Image transfer belt having a polymeric coating on a conductive substrate on a polymeric film

(75) Inventors: Leonard Stulc, Shafer, MN (US); Truman Frank Kellie, Lakeland, MN (US); Charles W. Simpson, Lakeland, MN (US); Jiayi Zhu, Woodbury, MN (US); A. Kristine Fordahl, Hopkins, MN (US)

Correspondence Address: Mark A. Litman & Associates, P.A., York Business Center, Suite 205, 3209 West 76th St., Edina, MN, 55435, US

(73) Assignee: SAMSUNG Electronics Co. Ltd.

(21) Appl. No.: 10/644,655

(22) Filed: Aug. 21, 2003

Related U.S. Application Data
(60) Provisional application No. 60/423,434, filed on Oct. 31, 2002.

(51) Int. Cl. G03G 15/16

(52) U.S. Cl. 399/308

(57) ABSTRACT

An electrophotographic imaging apparatus has a first toner accepting layer and an intermediate transfer member. The first toner accepting layer is positioned in electrical contact with a) a charge provider, b) an irradiation source that activates photoconductivity in the first toner accepting layer, and b) at least one toner applicator, so that a first toner image can be formed on the first toner accepting layer. The first toner layer is movable (after interaction with a), b) and c)) into contact with the intermediate transfer layer from which the first toner image can be transferred to an image bearing member. The intermediate transfer member comprises a non-conductive flexible film layer, a layer of an electrically conductive material affixed to a first surface of the non-conductive flexible film layer, and the electrically conductive material layer has an electrically resistive polymeric coating thereon.

### BACKGROUND OF THE INVENTION

1. Field of the Invention

This invention relates to new and unique image transfer members for use in electrophotographic printing in which the image transfer member is used to transport the image between the photoconductive drum and the final image receiving media. The new image transport members are easy to manufacture and allow the use of a simplified printer configuration.

2. Background of the Invention

In the electrophotographic printing process a toner image is formed on a photoconductive drum using electrostatic techniques that are well known in the art. In electrophotography, an organophotoreceptor in the form of a plate, belt, disk, sheet, or drum having an electrically insulating photoconductive element on an electrically conductive substrate is imaged by first uniformly electrostatically charging the surface of the photoconductive element, and then exposing the charged surface to a pattern of light. The light exposure selectively dissipates the charge in the illuminated areas, thereby forming a pattern of differentially charged areas of charged, lesser charged and minimally charged areas. A liquid or solid ink is then deposited in either the charged or uncharged areas to create a toned image on the surface of the photoconductive element. The resulting visible ink image can be fixed to the photoreceptor surface or transferred to a surface of a suitable receiving medium such as sheets of material, including, for example, paper, metal, metal coated substrates, overhead projection film, composites and the like. Prior to transfer to a suitable receiving medium, the visible ink image may be transferred to an intermediate transfer member (ITM) that is in contact and forms a nip (“T-1”) with the photoconductive drum. The image is then transported by the ITM to another contact nip (“T-2”) where the image is transferred to the final receiving medium. Imaging processes wherein a developed image is first transferred to an intermediate transfer member and subsequently transferred from the intermediate transfer member to an image receiving substrate are known.

U.S. Pat. No. 4,796,048 (Bean) discloses an apparatus which transfers a plurality of toner images from a photoconductive member to a copy sheet. A single photoconductive member is used. The apparatus may include an intermediate transfer belt to transfer a toner image to a copy sheet with the use of a biased transfer roller. The intermediate transfer belt has a smooth surface, is non-absorbent and has a low surface energy.

U.S. Pat. No. 4,708,460 (Langdon) discloses an intermediate transport belt that is preferably made from a somewhat electrically conductive silicone material having a volume resistivity of 10⁹ ohm-cm so that the belt is semi conductive.

U.S. Pat. No. 4,430,412 (Miwa et al.) discloses an intermediate transfer member, which may be a belt-type member that is pressed onto an outer periphery of a toner image retainer with a pressure roller. The intermediate transfer member is formed with a laminate of a transfer layer comprising a heat resistant elastic body such as silicone elastomer or rubber or fluoroelastomer fluorine polymer based rubber, and a heat resistant base material such as stainless steel.

U.S. Pat. No. 3,893,761 (Buchan et al.) discloses a xerographic heat and pressure transfer and fusing apparatus having an intermediate transfer member which has a smooth surface, a surface free energy below 40 dynes per centimeter and a hardness from 3 to 70 durometer (Shore A) hardness. The transfer member, preferably in the form of a belt, can be formed, for example, from a polyimide film substrate coated with 0.1-10 millimeters of silicone rubber or fluoroelastomer. Silicone rubber is the only material shown in the example as the transfer layer.

U.S. Pat. No. 5,099,286 (Nishishe et al.) discloses an intermediate transfer belt comprising electrically conductive urethane rubber reportedly having a volume resistivity of 10³ to 10⁴ ohm-cm and a dielectric layer of polytetrafluoroethylene reportedly having a volume resistivity equal to or greater than 10¹⁴ ohm-cm.

U.S. Pat. No. 5,208,638 (Bujese et al.) relates to an intermediate transfer member comprising a fluoropolymer with a conductive material dispersed therein as a surface layer upon a metal layer, which in turn is upon a dielectric layer. The conductive material is dispersed within the fluoropolymer and is not merely in a separate layer beneath it.

U.S. Pat. No. 5,233,396 (Simms et al.) discloses an apparatus having a single imaging member and an intermediate transfer member which is semiconductive and comprises a thermally and electrically conductive substrate coated with a semiconductive, low surface energy elastomeric outer layer that is preferably Viton® B-50 (a fluorocarbon elastomer comprising a copolymer of vinylidene fluoride and hexafluoropropylene).

U.S. Pat. Nos. 4,684,238 (Till et al.) and 4,690,539 (Radulski et al.) disclose intermediate transfer belts composed of polyethylene terephthalate or other suitable polypropylene materials.

U.S. Pat. No. 5,119,140 (Berkes et al.) discloses a single layer intermediate transfer belt preferably fabricated from clear, carbon loaded or pigmented Tedlar® (a polyvinylfluoride available from E.I. du Pont de Nemours & Co.). Tedlar® suffers from poor conformability.

U.S. Pat. No. 5,298,956 (Mammino et al.) discloses a seamless intermediate transfer member comprising a reinforcing belt member coated or impregnated with a filler material of film forming polymer that can include fluorocarbon polymers.

There are several advantages to using an ITM in electrophotography, especially where multiple colors are used. It is desirable to maximize the print output speed and the fastest of these options is known as the “one pass process” which requires four photoconductive drums in series for each of the four toner process colors. These four photoconductive drums are in contact with the ITM which is either a belt or drum to form four T-1 nips. In the case of a belt, biased rollers typically contact the backside of the ITB, creating stability, forming the nips and providing the electrostatic impetus for toner particle transfer. The ITM facilitates toner transfer from the ITM to a final recording medium by contacting and forming a nip with another biased roller (referred to as T-2). The toner images are first overlaid in register onto the ITM and then transferred from the ITM to the final receiving medium by passing the medium through the T-2 nip. An image transfer belt (ITB) is preferred because of increased flexibility in printer design and space savings over a large image transfer drum. The use of the “one pass process” also increases the life of an electrophotographic device since two to four passes are no longer required to obtain a multicolor image. The use of an ITB further results in a compact printer with small exterior dimensions and easy placement in cramped office space.

To be effective, an ITB has several requirements. First, an ITB should have the proper electrical properties to support a bias voltage across each T-1 nip and the T-2 nip. The toner image that is formed on the photoconductive drum consists of very small discreet charged colored particles. This bias voltage is used to induce electrostatic transfer of the toner particles of each image from each photoconductive drum to the ITB at each T-1 nip. A bias voltage is also used to transfer the toner image from the ITB to the final receiving media at the T-2 nip.

A second requirement of an image transfer belt is dimensional stability. This is necessary for accurate registration at the T-1 nips of each color plain of multicolor prints and also for accurate positioning of the image onto the final receiving media.

A third requirement in an image transfer belt is thickness uniformity over the entire area of the ITB. This is necessary to provide uniform and constant pressure in each toner transfer nip to facilitate complete and consistent transfer of toner images.

A fourth requirement of an ITB is durability and long life in a printer.

A bias voltage across each transfer nip is used to induce transfer of all the discrete charged toner particles that make up each of the images that were initially formed on each of the photoconductive drums. The bias voltage creates an electric field that must have the proper electrical orientation to move toner particles from one surface to the next at each transfer nip and on through the printer to the final receiving media. If a toner with a positive charge is used, the electric field must be oriented so that a negative charge is produced on the receiving surface or an adjacent supporting surface in contact with the receiving surface. If a toner with a negative charge is used, the electric field must be oriented so that a positive charge is produced on the receiving surface or an adjacent supporting surface in contact with the receiving surface. The orientation of the electric field is controlled by the orientation of the electrical power supply when connected to the bias voltage circuit. In past printers, this bias voltage circuit consists of a power supply, the photoconductive drums, electrically conductive ITB back up rollers and the roller supporting the final receiving media. The ITB back up rollers are preferably electrically isolated from the rest of the printer and the photoconductive drums as is the roller supporting the final receiving media. That portion of the ITB located in each transfer nip during ITB rotation is also part of this circuit. As a consequence, the electrical properties of the ITB must be controlled in a way that allows a bias voltage and strong electric field to be maintained at each toner transfer nip for good toner transfer efficiency. If the ITB is too electrically conductive, current will flow through the transfer nip and a bias voltage will not be possible. If the ITB is too electrically resistive, the electric field strength will decrease with increasing ITB thickness. In the prior art, belts that were made thicker to increase ITB durability and longevity suffered adverse effects on electric field strength. Conductive materials have therefore been added to past ITB's to adjust the electrical properties so that the electric field partially emanates from within the ITB. As a consequence printer configuration requires intimate contact between the ITB and the ITB back up rollers. Contamination of the ITB back up rollers can result from paper lint and/or stray toner and cause poor roller-to-ITB contact which reduces the strength of the electric field. This results in inconsistent toner transfer across the ITB surface.

Image transfer belts currently used in electrophotographic printers can be classified into two categories. There are single layer ITB's and multilayer ITB's. In both cases, complex and difficult manufacturing processes must be employed to produce a functional ITB that meets the requirements specified above.

The difficulties in manufacturing of image transfer belts have been discussed in the prior art. For example, see U.S. Pat. No. 6,397,034 (Tamawskj, et al.). Here, image transfer belts are made one at a time using monomeric and oligomeric species. Complicated carbon black dispersions and spin casting techniques are used to put a layer of uncured prepolymeric material onto the inside of a metal cylinder. A high temperature curing process is used to bring durability to the final ITB. Belt like structures are produced upon removal from the casting cylinder.

U.S. Pat. No. 6,228,448 (Ndebi et al.) describes endless belts for use in digital imaging processes that are made one at a time by winding cord or fabric impregnated with various uncured elastomers around a mandrel followed by wrapping with a plastic jacket and heat curing. The cord or fabric is required to provide suitable belt dimensional stability and durability. A cylindrical belt is produced upon removal from the mandrel. This process requires significant time and highly specialized equipment.

U.S. Pat. No. 5,409,557 (Mammino et al.) describes an endless intermediate transfer member made using reinforcing monofilament or a reinforcing sleeve made from woven fiber. The monofilament is wound onto a stainless steel mandrel or the sleeve is placed over a stainless steel mandrel. The reinforcing member is then spray coated with a solution of film forming polymer using repeated spray passes to build up a layer of sufficient durability and then the coating is slowly dried at ambient temperatures overnight and then oven cured at 100° C. The slow drying at ambient temperature is apparently to prevent blistering during solvent evaporation from the thick spray coated layer. An endless belt is produced upon removal from the mandrel. This is a slow manufacturing process producing only a single ITB at a time.

U.S. Pat. No. 5,899,610 (Enomoto et al.) describes a process for making an ITB in which an uncured rubber base material is formed on the inside of a centrifugal forming device followed by the application of a surface layer. The belt is then removed from the centrifugal forming device. This process again requires specialized equipment and produces image transfer belts one at a time.

Image transfer belts made by all of these processes require the use of electrically conductive rollers contacting the inner surface of the belt to form the electrical circuit necessary to impart the bias voltage required for electrostatic toner transfer at the T-1 and T-2 nips. This increases the complexity of the electrical circuitry in a printer and brings about uncertainty of electrical continuity between the conductive backup roller and the ITB especially when unwanted stray paper lint and toner contaminate this backup roller/ITB contact point.

In typical image transfer belts, the layer that provides dimensional ITB stability usually consists of a polymeric film or a woven fabric or wound thread that is impregnated with an elastomeric compound. In both cases, monomeric or oligomeric materials are applied as viscous liquids to either the outside of mandrels or the inside of cylinders. These mandrels and cylinders must be precisely machined to make an ITB of the proper size. Techniques used to apply the monomers and/or oligomers must also have high precision to obtain the required thickness uniformity over the entire area of the ITB. The applied monomers and oligomers are then cured by heat or UV (ultraviolet) radiation and polymerized to form either a polymeric film or polymeric elastomer. A cylindrical belt is obtained upon removal of the cured polymer matrix from the mandrel or cylinder. Specialized equipment with high precision is necessary to produce an ITB in this way. Also the cured polymers and elastomers by themselves are too electrically resistive at an ITB thickness that provides acceptable durability resulting in a weak electric field and poor toner transfer efficiency. Because of this, materials such as carbon particles and/or metal powders and/or other conductive ingredients must be used to adjust the electrical properties of the ITB. These particulates are distributed throughout the cured polymeric ITB supporting structure. This requires dispersing these particulates into the viscous monomeric and/or oligomeric materials prior to the belt making operation. A paste-like consistency can result in making application to the mandrel or cylinder difficult unless the viscosity of the paste-like dispersion is reduced by heating. Solvents which could be added to reduce the viscosity of the dispersion cannot be used because the application thickness required for ITB durability is large enough to cause solvent trapping during the curing process and subsequent blistering which reduces ITB yield. These manufacturing processes are also labor intensive with a low ITB output rate. All of this results in a high ITB cost. The ITB in the present invention has eliminated all of the complexities of past ITB manufacture while still producing an ITB with all the required ITB functional properties. This invention provides image transfer belts that use relatively thin coatings on durable films to facilitate easy manufacture, and to meet ITB functional requirements at a cost greatly reduced from transfer belts made using previously known processes.

### SUMMARY OF THE INVENTION

The concepts revealed in this description of the present invention will provide an ITB that greatly reduces the complexity of printer electrical configuration and eliminates toner transfer inconsistency due to ITB back up roller contamination.

In one aspect of the invention, an intermediate transfer member is described. In the most basic embodiment, the intermediate transfer member has three layers: a non-conductive layer such as film (e.g., electrically insulating or insulative film, by way of non-limiting example, especially polymeric insulative film), a conductive layer on top of the non-conductive layer, and an electrically resistive polymeric layer on top of the conductive layer. The non-conductive film layer can be any flexible substrate that will insulate the electrically energized (charged) second layer from metal (or other) support rollers; such material may preferably include polyesters such as polyethylene terephthalate (PET) or polyethylene naphthalate (PEN) in one embodiment of the invention. Typically, a PET film substrate might be between 2 and 10 mils (0.05 and 0.25 mm) thick, although any thickness that is flexible will work.

One embodiment of the intermediate transfer member describes a metal, metal filled layer, or semimetal or semimetal filled layer (such as aluminum) as the electrically conductive layer. Other conductive layers, such as conductive polymers, carbon filled layers or other conductive particle filled layers may be used. The conductive layer material may or may not be vapor-coated onto the non-conductive layer for thinness and flexibility. The conductive layer material will preferably have a volume resistivity of less than or equal to 10⁴ ohm-cm.

One embodiment of the electrically resistive polymeric coating describes polyurethane coatings. Typically the best working range for polyurethane coatings is with a resistance per unit area (often described in terms of ohms/square in the art, as the area units are immaterial) equal to or between 10⁶ and 10¹³ ohms/cm².

Another embodiment of the electrically resistive coating describes coatings made using fluorosilicone prepolymers. Typically the best working range for the electrically resistive layer made using fluorosilicone prepolymers is an electrical resistance per unit area equal to or between 10⁶ and 10¹³ ohms/cm².

Another aspect of the invention is a method of producing an image in an apparatus. The steps include a first step of exposing and developing at least one image on at least one image receiving member. A second step includes: transferring the image or images to an intermediate transfer member such as the one described above, having a substantially non-conductive layer, a conductive layer, and a resistive layer; the intermediate transfer member being conformable to the image receiving member and being charged by applying a voltage directly to the conductive layer by a brush or probe directly in contact with the conductive layer. A third step describes transferring the image or images to a receiving substrate, to achieve close to 100% toner transfer.

### DETAILED DESCRIPTION OF THE INVENTION

An intermediate transfer member (ITM) is described and the ITM is used, for example, in the transfer of intermediate images during an imaging process. For example, a first toner image is formed on a first image bearing member and the first toner image is primarily transferred (first transferred) onto the intermediate transfer member. After this first transfer step in the process, the toner image thus transferred is secondarily transferred (second transfer step) onto a second image bearing member. The intermediate transfer member comprises a non-conductive film layer, the non-conductive film layer having a layer of an electrically conductive material affixed thereto, and the electrically conductive material layer having an electrically resistive polymeric coating. The intermediate transfer member may have the non-conductive film layer comprise a polymeric material, by way of non-limiting examples, polyimides, polyamides, polycarbonates, polyacrylates, polyethers, polyurethanes, polyvinyl resins, cellulosic polymers including cellulose acetates and cellulose triacetate, and polyesters, such as polyethylene terephthalate (PET) and polyethylene naphthalate (PEN). The intermediate transfer member may, by way of non-limiting example, be between 1 and 10 (0.05 and 0.025 mm) or between 3 and 6 mils (0.08 and 0.15 mm) thick. The electrically conductive layer of the intermediate transfer member is a conductive material, such as conductive particle filled layers, metal layers, semimetal layers, or metal filled layers, and the metal is preferably aluminum.

The electrically conductive material layer may be vapor coated on the non-conductive film layer. The intermediate transfer member may have the electrically conductive material layer have a volume resistivity less than or equal to 10⁴ ohms-cm. The resistive polymeric layer may, by way of non-limiting example, have a resistance per unit area of between 10⁶ and 10¹³ ohms/cm². A preferred electrically resistive coating comprises polyurethane, especially where the polyurethane layer has a resistance per unit area equal to or between 10⁶ and 10¹³ ohms/cm² or a fluorosilicone prepolymer where the fluorosilicone layer has a resistance per unit area equal to or between 10⁶ and 10¹³ ohms/cm². The term fluorosilicone is well understood in the art to include materials, usually of a condensed or hydrolysis reacted product through silane groups or other reactive silicon containing groups, which have a fluorocarbon substituent group or groups. The pendant fluorocarbon groups (e.g., fluoroalkyl, fluoroalkoxy, ethers of fluoroalkyl groups, and the like) provide essential physical properties and contribute to chemical inertness of the fluorosilicon. These materials are well known in the art and are commercially available from 3M co. (St. Paul, Minn.), General Electric Co., specialty chemicals division (Schenectady, N.Y.) and E.I. duPont de Nemours, Inc.

A method for producing an image in an apparatus according to the invention may comprise exposing and developing at least one image on at least one image receiving member; and transferring the at least one image to an intermediate transfer member, wherein the intermediate transfer member comprises a non-conductive layer, a conductive layer, and an electrically resistive layer, wherein the resistive layer of the intermediate transfer member is conformable to the image receiving member, and wherein the conductive layer is charged by applying a voltage directly to the conductive layer by a brush or probe directly in contact with the conductive layer; and transferring the at least one image to an image receiving substrate, wherein the method results in a high degree (at least 90%, at least 93%, at least 95%, or at least 97%) or substantially 100% (at least 99%) toner transfer.

### DETAILED DESCRIPTION OF THE INVENTION

In the present invention, an endless image transfer belt is made using durable nonconductive film such as polymeric film, such as polyester film, and most preferably polyethylene terephthalate (PET) film that has been vapor coated on one side with a thin layer of an electrically conductive material such as metal or semimetal material; one such electrically conductive material is aluminum. (This material will subsequently be referred to as Al/PET, although other nonconductive materials and other metallic and non-metallic conductive materials are known and contemplated within the practice of the invention). Al/PET is dimensionally stable, has excellent thickness uniformity, excellent durability and is readily available in long thin webs of various widths and thicknesses and can be obtained in coils up to 5,000 feet long. Al/PET webs can be coated in a continuous operation using common high speed, coil to coil precision web coating techniques such as knife coating, reverse roll coating, extrusion coating, curtain coating and the like.

In the present invention, Al/PET is precision coated with an electrically resistive film forming polymeric material. Suitable polymeric materials include but are not limited to polydialkylsiloxanes, polyalkylarylsiloxanes, polyvinyl acetals, polyvinylbutyrals, polycarbonates, polyurethanes, polyesters, polyamides, vinylchloride/vinyl acetate copolymers, polyacrylates. polymethacrylates, cellulose acetate butyrate, and various fluoropolymers including ETFE, FEP, PFA, and THV. Various polymeric elastomers and rubbers can also be used and include butadiene-acrylonitrile rubber, chloroprene rubber, epichlorohydrin rubber, fluorosilicone elastomers, fluoroelastomers, nitrile butadiene rubber, polyacrylate rubber, polyether rubber, polyurethane elastomers, silicone rubber, polysulfide rubber and the like. Coatings containing dispersed particulates can also be used.

The polymeric coating is applied onto the side of the Al/PET having the thin layer of vapor coated aluminum or other conductive material and forms the toner transfer surface in a printer. The Al/PET with the polymeric coating is then cut into sheets of the proper size and the ends of these sheets lapped and ultrasonically welded to form a durable endless belt. The sheet size is controlled so that the welded endless belt will fit into an electrophotographic printer.

The electrical properties of the polymeric coating are controlled so that a bias voltage can be supported across this layer. This is done by controlling the dry coating thickness and by proper selection and formulation of the polymeric coating, which in turn adjusts the electrical resistance per unit area. A comparative measure of electrical resistance per unit area can be obtained by using an instrument consisting of an adjustable electrical power supply with voltage control, a precision amp meter and a surface contact electrode. An instrument suitable for determining volume resistivity can be used. Such an instrument can be set up by combining a Resistance/Current Meter Model 278 which consists of an adjustable electrical power supply and a precision amp meter with a Model 803B surface contact electrode both manufactured by Electro Tech Systems Inc. of Glenside, Pa. The resistance per unit area of a coating on Al/PET can be measured by placing the surface contact electrode on the polymeric coating and connecting the underlying aluminum layer to the amp meter. A comparative value for electrical resistance per unit area is obtained by applying 500 volts through the coating (similar to the bias voltage used in a printer) and measuring the current with the precision amp meter. Resistance per unit area in ohms/cm² is determined by dividing the applied voltage (in this case, 500 volts) by the measured current in amps. This result is then divided by 7.07 cm², which is the area of the Model 803B surface contact electrode, to obtain resistance per unit area in ohms/cm². If the surface contact electrode has an area of 1.0 cm² then resistance per unit area in ohms/cm² is obtained directly by dividing the applied voltage by the measured current in amps.

The width of the polymeric coating is also controlled so that a 10-30 mm wide strip of vapor coated aluminum along one edge of the web is left uncoated by the polymer so that electrical contact may be made to the aluminum strip from the surface. During operation in a printer, a conductive brush or roller contacts this aluminum strip as part of the electrical circuit that is necessary to induce electrostatic toner transfer. This allows the underlying electrically conductive, vapor coated aluminum layer to be electrically energized across the entire surface plane of the ITB. Application of a bias voltage across the electrically resistive polymeric coating results in a uniform electric field across the entire surface of the transfer belt. This induces electrostatic toner transfer either from the photoconductive drum to the ITB or from the ITB to the final receiving media. In a printer the nonconductive PET film which forms the durable and flexible support for the ITB rotates on supporting rollers. Electrical contact between these back up rollers and the ITB is not necessary as required with past ITB's.

An ITB made as specified in this invention allows the use of simplified printer circuitry by use of only a continuity brush or roller to contact the electrically conductive strip on the belt edge so that the ITB can be electrically energized without the need for electrically conductive ITB back up rollers and the resulting need for uniform electrical contact between the back up roller and the ITB. An ITB made as specified in this invention also allows for simplified high speed manufacture eliminating the manufacturing complexities inherent in past ITB constructions and allows for trouble-free operation of the printer.

### EXAMPLE 1

A polyurethane from Noveon Inc. (of Cleveland, Ohio, USA) with the trade name Estane® 5778 was coated on to an Al/PET substrate and then made into an ITB. This was accomplished by first preparing a 20% solution of the Estane® 5703 in methylethyl ketone (MEK). 200 grams of pelletized Estane® 5778 was added to 800 grams of MEK in a glass jar. The glass jar was tightly capped and mounted on an oscillating shaker. The shaker was turned on and the Estane® 5778 was brought to a clear solution after 12 hours.

A roll to roll coater with an extrusion type coating bar was used to apply the Estane® 5778 solution to the Al/PET web. The coating bar has a narrow extrusion slot oriented perpendicular to the web and is positioned so that liquids and solutions can be applied to the Al/PET web as a thin liquid coating as the Al/PET web is pulled past the extrusion slot. A positive displacement pump and associated plumbing is used to meter the coating liquid through the extrusion bar slot and onto the moving web. The positive displacement pump has a maximum fluid pumping rate of 292 cc/min. Both the wet film coating thickness and the coating width can be controlled with high precision. The web passes through a heated forced air oven to dry and cure the coating and the temperature of the drying oven can be controlled as needed.

A coil of 3 mil Al/PET was mounted onto the unwind stand of the roll to roll coater. The 3 mil Al/PET web was threaded past the coating extrusion bar and on through the heated forced air drying oven and on further to a receiving drum mounted on the wind up stand. The width of the extrusion slot was adjusted and the extrusion slot positioned relative to the Al/PET web so that a 15 mm wide strip of vapor coated aluminum along one edge remained uncoated. The coater oven temperature was brought to 130° C. The Estane® 5778 solution was diluted to 15.0% solids by adding an additional 333.3 grams of MEK to the 1000 grams of solution prepared earlier. This solution was then pumped to the extrusion bar slot and onto the moving Al/PET web. The web speed was set at 3.0 ft/min (1 m/min.). and the pump speed set at 7.5 rpm. After drying in the coater oven a total of 200 ft. (65 meters) of a dry uniform coating was produced on the Al/PET web which was wound into a coil on the wind up drum. The thickness of the Estane® 5778 coating was measured using a thickness gauge from Brunswick Instrument and found to be 3 microns thick. This coating was labeled “condition 1.” The resistance per cm² of the Estane® 5778 coating on Al/PET was measured at 500 applied volts and found to be 5.3×10¹⁰ ohms/cm².

Condition 1 was made into an ITB by cutting it into sheets 330 mm wide and 812 mm long using a precision template. The ends of the 812 mm dimension were overlapped by 20 mils (0.5mm) on the anvil of an ultrasonic welder made by the Branson Co. (Danbury, Conn., USA) and fused together to form an endless belt of the proper size for a laboratory test bed printer. This belt was labeled ITB #1.

ITB #1 was mounted on the transfer frame of a laboratory test bed printer and was used to produce excellent multicolor prints on both paper and OHP film. Electrical contact to the uncoated conductive ITB edge strip of vapor coated aluminum was by use of a conductive brush. A uniform bias voltage across the entire plain of the ITB was used to induce toner transfer at both T-1 and T-2.

### EXAMPLE 2

A fluorosilicone prepolymer from General Electric Co. (Schenectady, N.Y., USA) with the designation FRV1106 was coated onto Al/Pet and then made into an ITB. This was accomplished by first preparing a 40% solution of FRV1106 in MEK. 398.4 grams of FRV1106 and 1.6 grams of tetrabutyl titanate (TBT) catalyst from Du Pont were added to 600 grams of MEK in a glass jar. The jar was tightly capped and the FRV1106 brought into solution by putting the jar on an oscillating shaker for 4 hours. This solution was then coated onto Al/PET using the extrusion coater described in Example 1. In this example, 30 foot (10 m) sections of the web were extrusion coated in intervals and with each section being stopped for 5 minutes in the oven to allow the fluorosilicone prepolymer to cure to a durable polymeric elastomer before being wound into a coil on the wind up stand. The web speed was 5 ft/min. (1.6 m/min.) and the oven temperature was 130° C. A first fluorosilicone coating on Al/PET was made with a pump speed of 16 rpm. This coating had a dry thickness of 8 microns and was labeled condition 2. A second fluorosilicone coating was made with a pump speed of 32 rpm. This coating had a dry thickness of 12 microns and was labeled condition 3. The resistance per cm² at 500 applied volts for condition 2 was found to be 1.2×10⁹ ohms/cm². The resistance per cm² at 500 applied volts for condition 3 was found to be 1.5×10⁹ ohms/cm².

Conditions 2 and 3 were cut into sheets 330 mm by 812 mm sheets with a precision template and these sheets ultrasonically welded into image transfer belts (ITB's) as done in example 1. These 2 endless belts were labeled ITB #2 and ITB #3 representing respectively coating conditions 2 and 3.

ITB #2 was mounted on the transfer frame of a laboratory test bed printer and was used to produce excellent multicolor prints on both paper and OHP film. ITB #3 was also mounted on the transfer frame of a laboratory test printer and was used to produce excellent multicolor prints on both paper and OHP film. A conductive brush in contact with the uncoated ITB edge strip was again used to maintain electrical contact to the underlying vapor coated aluminum. The applied bias voltage necessary for toner transfer was therefore uniformly applied across the entire surface of the ITB.

### EXAMPLE 3

A polyurethane resin from Air Products Inc. (i.e., HYBRIDUR™-580 from Allentown, Pa., USA) designated HD580 was coated onto Al/PET. This was accomplished by preparing a 15% solids solution with 50% water and 50% ethyl alcohol. An associated rheology modifier ACRYSOL™ SCT-275 acrylate from Rohm and Hass Co. (Philadelphia, Pa.) is incorporated at 4.0% of the HD580 solids to bring about a durable coating. The following solution was prepared:

| | Weight (grams) | |
|---|---|---|
| HD580 | 351.2 | (41% in 1/1 - water/EtOH as received) |
| Acrysol ® 275 | 6.0 | |
| Ethyl Alcohol | 321.4 | |
| Water | 321.4 | |

These materials were added to a glass jar and brought to uniform solution by shaking for 1 hour. This solution was then coated onto Al/PET as described in Example 1. A pump speed of 11.3 rpm was used to produce a coating that was 4.5 microns thick on the Al/PET. This was labeled condition 4. A pump speed of 22.7 rpm was used to produce a coating that was 8.0 microns thick on Al/PET. This was labeled condition 5. These 2 conditions were made into endless belts as described in example 1 and labeled ITB #4 and ITB #5 representing coating conditions 4 and 5. The electrical resistance per cm² of the coating used in condition 4 was measured at 500 applied volts and found to be 1.7×10⁸ ohms-cm². The electrical resistance per cm² of the coating used in condition 5 was measured at 500 applied volts and found to be 1.0×10⁸ ohms/cm².

ITB #4 was mounted on the transfer frame of a laboratory test bed printer and was used to produce excellent multicolor prints on both paper and OHP film. ITB #5 was also mounted on the transfer frame of a laboratory test printer and was used to produce excellent multicolor prints on both paper and OHP film. A conductive brush in contact with the uncoated ITB edge strip was again used to maintain electrical contact to the underlying vapor coated aluminum. The applied bias voltage necessary for toner transfer was therefore uniformly applied across the entire surface of the ITB.

Although specific examples and specific descriptions of materials, dimensions and equipment were provided in the examples, these examples are not intended to define minimum limits for the practice of the invention, but provide species examples of the generic concepts of the invention.

What is claimed:

1. An intermediate transfer member onto which a toner image is formed as a first image bearing member, and to which the toner image is first transferred and from which the first transferred toner image is transferred a second time onto a second image bearing member; the intermediate transfer member comprising;
a non-conductive flexible film layer,
a layer of an electrically conductive material affixed to a first surface of the non-conductive flexible film layer, and
the electrically conductive material layer having an electrically resistive polymeric coating thereon.

2. The intermediate transfer member of claim 1 wherein the electrically resistive polymeric coating coats less than all the conductive material, leaving a continuous electrical contact strip along an edge of the intermediate transfer member.

3. An electrophotographic imaging apparatus having a first toner accepting layer and an intermediate transfer member,
the first toner accepting layer positioned in electrical contact with a) a charge provider, b) an irradiation source that activates photoconductivity in the first toner accepting layer, and b) at least one toner applicator, so that a first toner image can be formed on the first toner accepting layer,
the first toner layer being movable after interaction with a), b) and c) into contact with the intermediate transfer layer from which the first toner image can be transferred to an image bearing member; the intermediate transfer member comprising;
a non-conductive flexible film layer,
a layer of an electrically conductive material affixed to a first surface of the non-conductive flexible film layer, and
the electrically conductive material layer having an electrically resistive polymeric layer thereon.

4. The intermediate transfer member of claim 2 wherein the non-conductive film layer comprises polyethylene terephthalate (PET).

5. The intermediate transfer member of claim 4 wherein the PET is between 0.05 mm and 0.25 mm thick.

6. The intermediate transfer member of claim 3 wherein the electrically conductive material layer comprises aluminum.

7. The intermediate transfer member of claim 3 wherein the electrically conductive material layer has been vapor coated on the non-conductive film layer.

8. The intermediate transfer member of claim 3 wherein the electrically conductive material layer has a volume resistivity less than or equal to 10⁴ ohm-cm.

9. The intermediate transfer member of claim 3 wherein the electrically resistive polymeric layer has an electrical resistance per unit area between 10⁶ and 10¹³ ohms/cm².

10. The intermediate transfer member of claim 3 wherein the electrically resistive layer is polyurethane.

11. The intermediate transfer member of claim 10 wherein the polyurethane layer has an electrical resistance per unit area between 10⁶ and 10¹³ ohms/cm².

12. The intermediate transfer member of claim 3 wherein the electrically resistive coating layer is a fluorosilicone prepolymer.

13. The intermediate transfer member of claim 11 wherein the fluorosilicone prepolymer has an electrical resistance per unit area between 10⁶ and 10¹³ ohms/cm².

14. The intermediate transfer member of claim 1 wherein the electrically resistive polymeric coating is additionally solvent resistant with respect to aliphatic hydrocarbons used as toner carrier liquid.

15. A method for producing an image in an apparatus comprising:
exposing and developing at least one image on at least one first image receiving member;
transferring the at least one image to an intermediate transfer member,
wherein the intermediate transfer member comprises a non-conductive layer, a conductive layer, and a polymeric electrically resistive layer,
wherein the electrically resistive layer of the intermediate transfer member is conformable to the first image receiving member, and
wherein the conductive layer is charged by applying a voltage directly to the conductive layer by a brush or probe directly in contact with the conductive layer; and
transferring the at least one image to a second image receiving substrate, wherein the method results in excess of 97% toner transfer from the intermediate transfer sheet to the second image receiving substrate.

16. The method of claim 15 wherein the method results in greater than 99% toner transfer from the intermediate transfer member to the second image receiving substrate.

17. The method of claim 15 wherein the method results in greater than 97% toner transfer from the first image receiving member to the intermediate transfer member to the second image receiving substrate.

18. The method of claim 15 wherein the method results in greater than 95% toner transfer from the first image receiving member to the intermediate transfer member to the second image receiving substrate.
